(19) United States
(12) Patent Application Publication
(10) Pub. No.: US 2025/0119709 A1
(43) Pub. Date: Apr. 10, 2025

(54) SYSTEMS AND METHODS FOR MICRO-LOCATION POSITIONING AND ANALYTICS

(71) Applicant: VOLAN TECHNOLOGY, INC., Hoboken, NJ (US)

(72) Inventors: Michael BETTUA, Hoboken, NJ (US); Timothy CHINOWSKY, Hoboken, NJ (US); Chi Ming TSE, Hoboken, NJ (US); Cameron TAHERI, Hoboken, NJ (US); Avery CUNNINGHAM, Hoboken, NJ (US); Andrew MARDER, Hoboken, NJ (US); Ka Kui CHENG, Hoboken, NJ (US); Wai Hey WILLIE IP, Hoboken, NJ (US); Kin Hin WONG, Hoboken, NJ (US)

(73) Assignee: VOLAN TECHNOLOGY, INC., Hoboken, NJ (US)

(21) Appl. No.: 18/730,526

(22) PCT Filed: Jan. 20, 2023
(86) PCT No.: PCT/US2023/060968

§ 371 Date: Jul. 19, 2024

Related U.S. Application Data
(60) Provisional application No. 63/267,030, filed on Jan. 21, 2022.

(51) Int. Cl. H04W 4/029; G01S 11/06; H04W 4/021; H04W 64/00

(52) U.S. Cl. CPC H04W 4/029; G01S 11/06; H04W 4/021; H04W 64/00

(57) ABSTRACT

Systems and methods are provided for monitoring a workforce within a site using a wireless mesh network.

### CROSS-REFERENCE TO RELATED APPLICATIONS

This application claims priority to U.S. Provisional Application No. 63/267,030, filed Jan. 21, 2022, which is herein incorporated by reference in its entirety.

### BACKGROUND OF THE DISCLOSURE

Labor is among the highest in cost and lowest in supply for many industrial companies. In order to remain competitive, companies are frequently searching for ways to realize potential labor cost savings, increase worker productivity, and improve operational efficiency. However, there has been no reliable way to capture and analyze real-time workforce movements on-site, nonetheless with high accuracy and at scale.

### BRIEF DESCRIPTION OF THE FIGURES

FIG. 1 is a block diagram of an example positioning system according to some embodiments of the present disclosure.

FIG. 2 is a block hardware diagram of an example sensor that can be used within the positioning system of FIG. 1 according to some embodiments of the present disclosure.

FIG. 3 is a block hardware diagram of an example beacon that can be used within the positioning system of FIG. 1 according to some embodiments of the present disclosure.

FIG. 4 is an example work zone and workforce being monitored by the positioning system of FIG. 1 according to some embodiments of the present disclosure.

FIG. 5 is a live map on a dashboard of the positioning system of FIG. 1 according to some embodiments of the present disclosure.

FIG. 6 is another live map on a dashboard of the positioning system of FIG. 1 according to some embodiments of the present disclosure.

FIG. 7 is an example analytics interface on the dashboard of the positioning system of FIG. 1 according to some embodiments of the present disclosure.

FIG. 8 is an example method for generating live tracking information within the system of FIG. 1 according to some embodiments of the present disclosure.

FIG. 9 is an example method for generating alerts within the system of FIG. 1 according to some embodiments of the present disclosure.

FIG. 10 is an example method for computing a labor cost within the system of FIG. 1 according to some embodiments of the present disclosure.

FIG. 11 is an example server device that can be used within the system of FIG. 1 according to an embodiment of the present disclosure.

FIG. 12 is an example computing device that can be used within the system of FIG. 1 according to an embodiment of the present disclosure.

### DESCRIPTION

The following detailed description is merely exemplary in nature and is not intended to limit the invention or the applications of its use.

Embodiments of the present disclosure relate to a micro-location positioning system and analytics platform. The disclosed system provides smart, micro-positioning data in a precise, reliable, and private manner. The positioning system operates via a mesh network topology (e.g., Bluetooth™), which means there is no dependency on smartphones, GPS, Wi-Fi, or power. GPS systems are often too slow and imprecise, which adds substantial inaccuracies to zone detection. The removal of such a dependency offers an ease of deployment and modifications. The system utilizes a plurality of beacons (herein referred to as a “beacon set”) positioned at various points through a work site or other region. The beacons can further be positioned such that combinations of beacons define smaller regions, such as a protected zone within a construction or manufacturing site or a room in a building. In addition, a sensor unit is carried by each member of the workforce subject to monitoring, which allows real-time micro-location data to be passively recorded as people move within digital zones of a facility or worksite. The location of each sensor is therefore determined (e.g., pinged every so often, such as every five seconds) relative to the beacons, and all location data can be transmitted and stored in a point cloud. In some embodiments, a point cloud can include a collection of data points, such as Cartesian coordinates, polar coordinates, and various others. The disclosed system also includes a server with an analytics engine to analyze workforce movements for identifying operational inefficiencies and preventing worker safety problems. The analytics can be accessed via an online platform on various user devices, where users can view live maps of the workforce, rosters, alerts, and other analytics, such as labor costs, time spent in certain areas, number of people monitored per supervisor, etc.

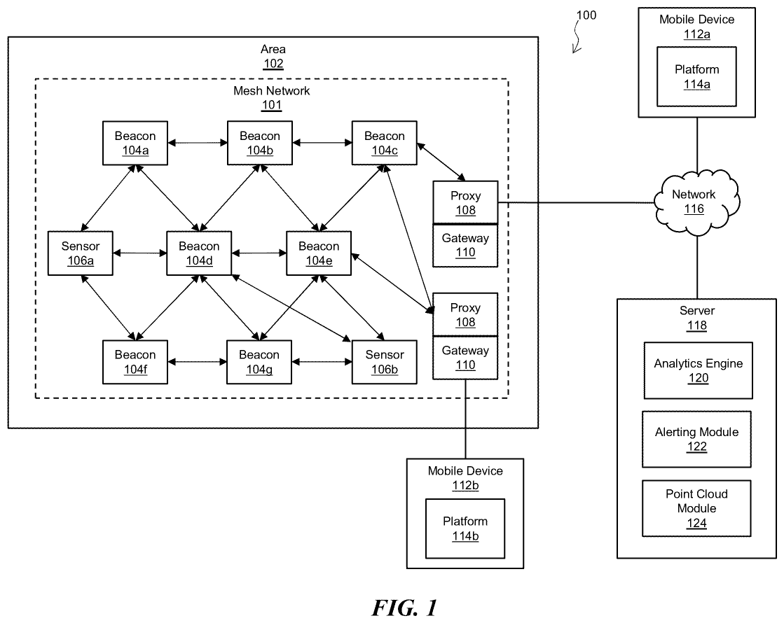

FIG. 1 is a block diagram of an example positioning system 100 according to some embodiments of the present disclosure. The positioning system 100 is configured to monitor an area 102, such as a construction site, a manufacturing site, an Olympic encampment, a school building, and the like. A mesh network 101 is positioned within the area 102 and communicably coupled, via a network 116, to a server 118 and a first mobile device 112a. In addition, the mesh network 101 can be connected via Bluetooth™ to a second mobile device 112b.

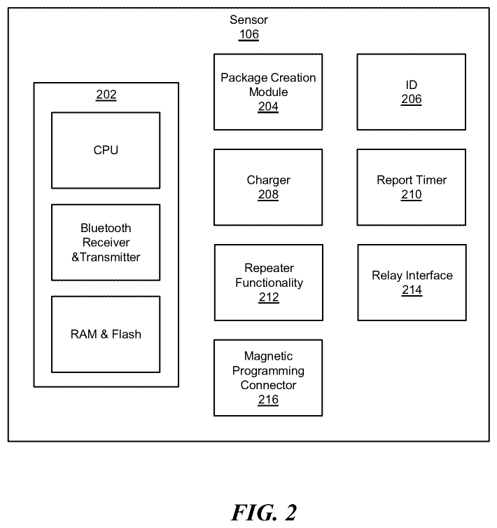

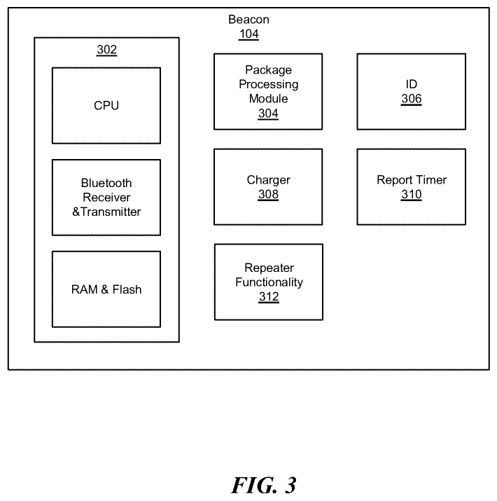

The mesh network 101 includes a plurality of beacons 104a-g (generally referred to herein as a “beacon 104” or collectively referred to herein as “beacons 104”), a plurality of sensors 106a-b (generally referred to herein as a “sensor 106” or collectively referred to herein as “sensors 106”), a proxy 108, and a gateway device 110. In some embodiments, a “proxy” ca include any device capable of operating between the mesh network 101 and the server 118 and translating BLE messages into a format that the server 118 can process. It is important to note that, while FIG. 1 shows one proxy 108 and one gateway device 110, multiples of these devices are also possible. Additional details with respect to the components within the sensors 106 and the beacons 104 are discussed in relation to FIGS. 2 and 3, respectively. Each beacon 104 and sensor 106 has an associated ID number maintained within the system 100. The beacons 104 are generally stationary units (although repositioning for the purpose of modifying a zone within the region 102 is possible) installed at various points within the region 102 and can be used to define zones (individual zones are not shown in FIG. 1) on a digital map. For example, four beacons can be installed within the four walls of a room to define the room as a zone. The system 100 (e.g., server 118) then defines that zone based on the four respective ID numbers of the beacons 104. Because the beacons 104 operate as part of the mesh network 101, no wiring or infrastructure is needed, and implementation can occur anywhere. In addition, the beacons 104 can be easily repositioned. In some embodiments, a sensor 106 may also be referred to herein as a portable unit and a beacon 104 may be referred to as a stationary unit.

The sensors 106 are generally mobile or portable units that are carried or worn by workforce members. Each sensor 106 has a unique ID, can specify a role for the associated employee, and can include a labor cost associated with the employee and/or role. Each sensor 106 is configured to repeatedly measure its own location relative to the beacons 104, recording a location data point every few seconds. Each location data point can be a data package (herein referred to as a “location package”). For example, each sensor 106 can be configured to find three nearby beacons 104 and place its own respective ID in the data package along with the IDs of the three beacons, a version number, and a timestamp. The data package is then transmitted to one or more beacons 104 (e.g., the three identified beacons 104) via the mesh network 101. The receiving beacon 104 then relays the data package to other beacons until it reaches a proxy 108, which can be attached to a gateway 110. The proxy 108 collects the data package from the relevant beacon 104 and transmits it to a respective gateway 110, which can be attached. The gateway 110 operates as a temporary storage site of data and a link to the server 118 via network 116. In some embodiments, gateways 110 can include a private Local Area Network (LAN), providing users with secure, local access to real-time location data.

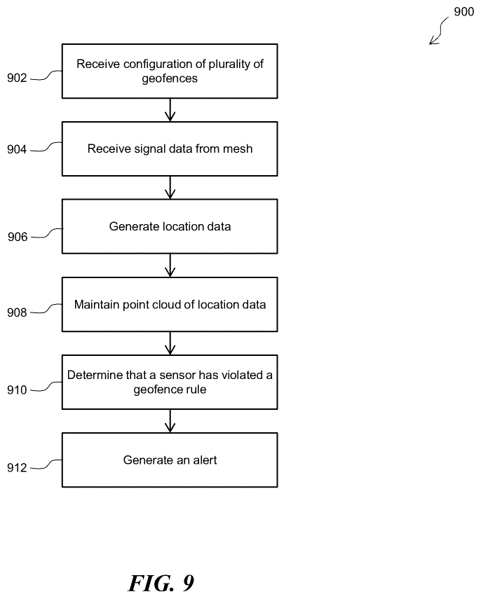

The server 118 includes an analytics engine 120, an alerting module 122, and a point cloud module 124 and is configured to utilize various algorithms to process signal strengths and received data packages to position sensors inside of the various zones defined by the beacons 104. The analytics engine 120 is configured to provide both real-time analytics and workforce insights. For example, the analytics engine 120 can pull positions of beacons 104 and sensors 106 and configurations (e.g., of site maps of area 102) and perform location positioning independent of any Internet connectivity. A live map with real-time locations can be generated for view on various user devices 112. Additional features can include live room rosters and emergency incident locations. Furthermore, the analytics engine 120 computes various analytics that allow users to gain operational insights about the movement of the workforce within the region 102. For example, the analytics engine 120 can perform time and motion studies, work zone analytics and comparisons, safety and security analytics, compliance audits, live searches for individuals, contract tracing analytics, and digital twin data for simulations. In addition, the analytics engine 120 can help provide insights such as the identification of operational inefficiencies and labor cost savings areas, the improvement of workplace productivity, the forecasting of labor needs, the prediction of workforce patterns, the increase of worker safety and security, and the identification of risk reduction areas. In some embodiments, the analytics engine 120 can analyze and report labor force movements between zones, such as by maintaining track of the amount of time certain sensors 106 take to move between one zone and another zone. In some embodiments, the analytics engine 120 is configured to generate and display a heat map reflecting various values, such as the number of employees or the cost associated with the area/zone. The analytics can be provided for display on the platform 114a that is accessible via a mobile device 112. The alerting module 122 is configured to maintain certain zone restriction rules and can detect infractions of such rules. In addition, the alerting module 122 can operate with other pre-defined rules that are discussed in relation to FIG. 9. Point cloud module 124 can store a point cloud of data points (i.e., packages from the sensors 106 over time) in Amazon Web Services (AWS) and can utilize various lambda functions to execute analytics on behalf of the analytics engine 120. In addition, the point cloud is regularly updated so that users can visualize and obtain up-to-date analytics right away.

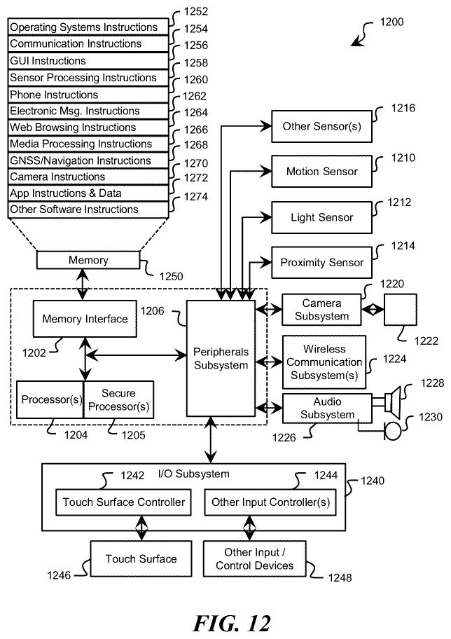

A mobile device 112 can include one or more computing devices capable of receiving user input, transmitting and/or receiving data via the network 116, and or communicating with the server 118. In some embodiments, a mobile device 112 can be a conventional computer system, such as a desktop or laptop computer. Alternatively, a mobile device 112 can be a device having computer functionality, such as a personal digital assistant (PDA), a mobile telephone, a smartphone, or other suitable device. In some embodiments, a mobile device 112 can be the same as or similar to the computing device 1200 described below with respect to FIG. 12. In some embodiments, the system 100 can include any number of mobile devices 112.

The network 116 can include one or more wide areas networks (WANs), metropolitan area networks (MANs), local area networks (LANs), personal area networks (PANs), or any combination of these networks. The network 116 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 116 can also use standard communication technologies and/or protocols.

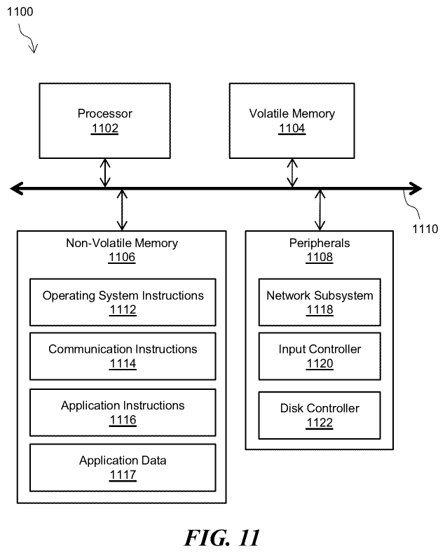

The server 118 may include any combination of one or more of web servers, mainframe computers, general-purpose computers, personal computers, or other types of computing devices. The server 118 may represent distributed servers that are remotely located and communicate over a communications network, or over a dedicated network such as a local area network (LAN). The server 118 may also include one or more back-end servers for carrying out one or more aspects of the present disclosure. In some embodiments, the server 118 may be the same as or similar to server 1100 described below in the context of FIG. 11.

FIG. 2 is a block hardware diagram of an example sensor 106 that can be used within the positioning system of FIG. 1 according to some embodiments of the present disclosure. Sensor 106 is configured to be worn, carried, or otherwise maneuvered by a person, such as an employee, athlete, member of a group, and the like. The sensor 106 can include communications and computing functionality 202, which includes a CPU, Bluetooth™ receiving/transmitting functionality, RAM, and flash memory. In addition, the sensor 106 can include a package creation module 204 and a variety of sub-routines 206-212, such as ID maintenance 206, a charger 208, a report timer 210, and repeater functionality 212. Repeater functionality 212 enables the sensor 106 to relay mesh message data between itself and other elements of the mesh network 101. Each sensor 106 can have a unique identifier (ID) associated with it, which is maintained by ID maintenance 206. The package creation module 204 is configured to generate a package of data via the necessary components, which can include finding three nearby beacons, determining their respective signal strengths, and placing their IDs and signal values into a package along with the respective sensor ID, version number, and a timestamp. Report timer functionality 210 enables the sensor 106 to automatically generate a package at present periods or at a present frequency. In some embodiments, a package generation can be performed in response to an interrogation, such as from an administrative node (not shown). In some embodiments, the frequency at which sensors 106 generate packages and report data can be set by an administrator of the area 102 or can have a default value, such as five seconds. In some embodiments, the sensor 106 can be configured to report its location via a received signal strength indication (RSSI) methodology. For example, broadcast data from the sensor 106 is sent to one or more beacons 104 (e.g., three nearest beacons) immediately surrounding the portable node. The beacons 104 that received the broadcast data can, in turn, send back RSSI information to the sensor 106. The sensor 106 then generates a package. In addition, the sensor 106 can include a relay interface 214 that can include battery life indicators (e.g., LEDs), a charging indicator, as well as a battery life-checking button and power switch. Finally, the sensor 106 can include a magnetic programming connector 216, which can be used to hold the sensor 106 in place at a station for charging and/or updates.

FIG. 3 is a block hardware diagram of an example beacon 104 that can be used within the positioning system of FIG. 1 according to some embodiments of the present disclosure. Beacon 104 can be positioned at a specific location as a more permanent fixture, such as a wall, pole, etc., although it is possible to be repositioned. Such positioning can be to define the boundaries of a room or specific region. The beacon 104 can include communications and computing functionality 302, which includes a CPU, Bluetooth™ receiving/transmitting functionality, RAM, and flash memory. In addition, the beacon 104 can include a package processing module 304 and a variety of sub-routines 306-312, such as ID maintenance 306, a charger 308, a report timer 310, and repeater functionality 312. The package processing module 304 is configured to receive a package from a sensor 106 and send the package to another beacon 104 or a proxy 108, depending on location. Repeater functionality 312 enables the beacon 104 to relay mesh message data between itself and other elements of the mesh network 101. Each beacon 104 can have a unique identifier (ID) associated with it, which is maintained by ID maintenance 306.

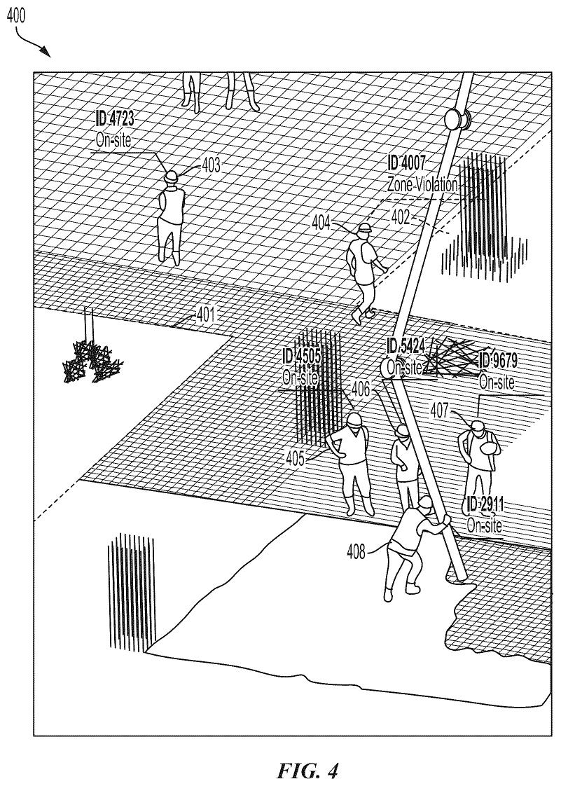

FIG. 4 is an example work zone 400 and workforce being monitored by the positioning system 100 of FIG. 1 according to some embodiments of the present disclosure. The work zone 400 includes regions 401 and 402. In this example, regions 401 and 402 are considered danger zones or some other type of region that is considered off limits. Each region 401 and 402 is defined by various beacons (usually four), such as beacons 104 from system 100, although these are not shown in the figure. In some embodiments, beacons 104 can be positioned along the perimeter of the region to be defined, such as at the four corners or at a midway point of each side. However, regions that can be defined using the embodiments described herein are not limited to quadrilateral shapes and various shaped regions can be defined. In addition, workers 403-408 are working in the work zone 400. Although not shown in the figure, each worker 403-408 has an associated sensor 106 with them (e.g., in a pocket, worn around a neck, etc.). Each worker 403-408 also has an employee ID, which is stored and maintained by the ID maintenance functionality 206 of each sensor 106. In addition, the server 118 (not shown) also maintains a record of the ID for each sensor 106. With such a system, an administrator or other user/supervising employee can monitor the movements and various other parameters of a workforce, such as by viewing analytics on an application platform. For example, a sensor carried by each of the employees 403-408 may generate and transmit a package at a pre-defined frequency (e.g., every five seconds), enabling the location of each of the employees 403-408 to be updated according to the pre-defined frequency. In this way, locations can be tracked and analyzed. In one example, an alert may be generated as employee 404 approaches the danger zone 402. Another alert can be generated if the employee 404 actually enters the danger zone 402.

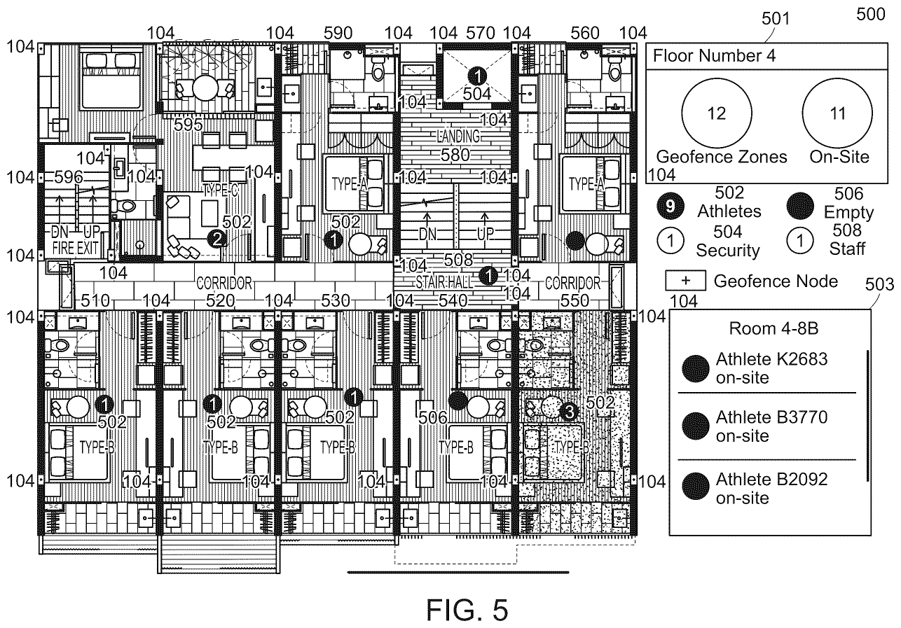

FIG. 5 is a live map 500 on a dashboard of the positioning system of FIG. 1 according to some embodiments of the present disclosure. In some embodiments, the live map 500 can be displayed a mobile device 112 via a platform 114. In addition, the live map 500 can be generated by the analytics engine 120 of the server 118. The live map 500 is a way for a user/administrator/supervising employee to monitor a workforce or other group of people. The live map 500 is used to monitor a group of athletes 502, security 504, and staff 508 and includes a plurality of beacons 104 that are positioned around the monitored region. The beacons 104 define rooms 510-590 and 595, fire exit 596, and stair hall 597. As discussed in relation to FIG. 4, each monitored person (athletes 502, security 504, and staff 508) has an associated sensor 106 (not shown), where each sensor 106 broadcasts its location in a package at a predefine frequency. For example, security personnel 504 generates a package, obtaining signal strengths from the four nearest beacons 104, which are the beacons 104 that define the room 570. The package contains the IDs of each of the beacons 104, the ID of the respective sensor 106, a version number, and a timestamp and is then transmitted to the beacons 104 (i.e., the repeater functionality 212 is engaged). Each of the beacons 104 continue to transmit the package to adjacent beacons 104 until it reaches a proxy 108 (not shown). The proxy 108 provides the package to the associated gateway 110, which transmits it to a server 118 for analysis. As the ID of the security personnel 504's sensor 106 can be stored with a corresponding role (i.e., security), the server 118, via analytics engine 120, determines that the location of the security personnel 504 is within room 570 and displays an indicator (e.g., a circle or other indicating shape or tracking object) within the room 570 on live map 500. Such location processing is determined repeatedly and simultaneously for the athletes 502 and the staff 508 in order to display a comprehensive live map 500 for tracking the members.

In some embodiments, the live map 500 can include a region label section 501, indicating that the region being viewed is Floor Number 4, that there are twelve geofence zones (i.e., rooms 510-590 and 595, fire exit 596, and stair hall 597) and eleven members (e.g., athletes 502, security 504, and staff 508) on site. In some embodiments, different positioning systems can be configured to monitor multiple floors of a building, and the user viewing the live map 500 can switch what floor is being viewed. In other embodiments, different regions can be switched to for viewing but may not necessarily correspond to different floors in a building. Rather, different regions may simply correspond to different regions in a similar plane at ground level. In addition, the live map 500 can include an active count of which rooms have what members, showing nine rooms have athletes 502, one had a security personnel 504, and one has staff 508. Live map 500 can also include a roster 503 that lists which members/sensors 106 (e.g., by ID number) are in certain rooms.

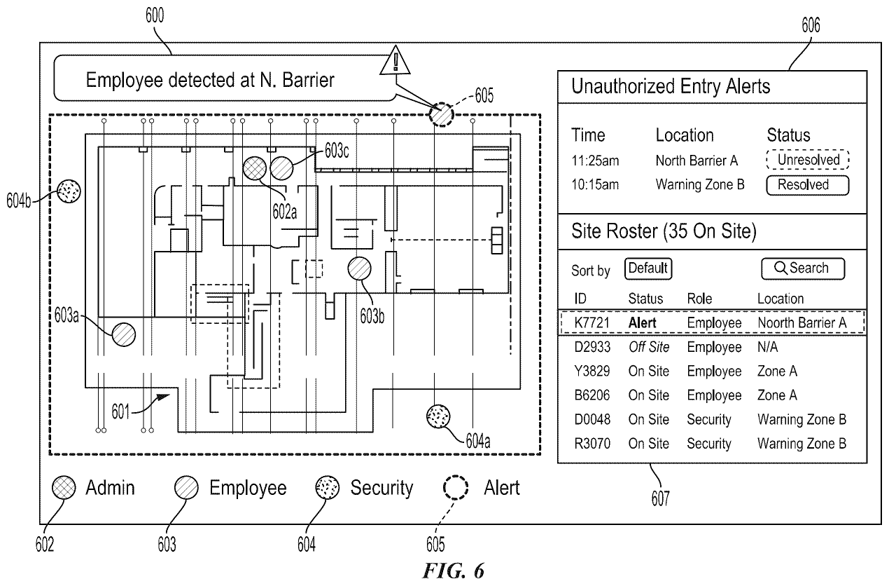

FIG. 6 is another live map 600 on a dashboard of the positioning system of FIG. 1 according to some embodiments of the present disclosure. Similar to live map 500, the live map 600 can be displayed a mobile device 112 via a platform 114. In addition, the live map 600 can be generated by the analytics engine 120 of the server 118. The live map 600 displays the location of an admin 602 (602a), employees 603 (603a-c), security 604 (604a-b), and shows an alert 605. An alert can be generated when it is determined that a member (e.g., an employee) is exiting the perimeter of the zone. When this is determined, an alert indicator 605 is displayed on the live map 600 along with a message, such as “Employee detected at N. Barrier.” In addition, the live map 600 can include a list 606 of unauthorized entry alerts (or other types of alerts). The list 606 includes two alerts, one of which being the alert 605 for the employee at the North Barrier. The list 606 can include a time of the alert, a location, and a status (e.g., unresolved or resolved). The list 606 also includes a resolved second alert of a member detected at a Warning Zone B at 10:15 am, although this is not shown. In some embodiments, the list 606 can further include a site roster 607 that lists the various members, displaying the ID, status (e.g., off-site or on-site), the role (e.g., employee or security), and location. The user viewing live map 600 can sort the roster by various filters and can search the roster using various keywords.

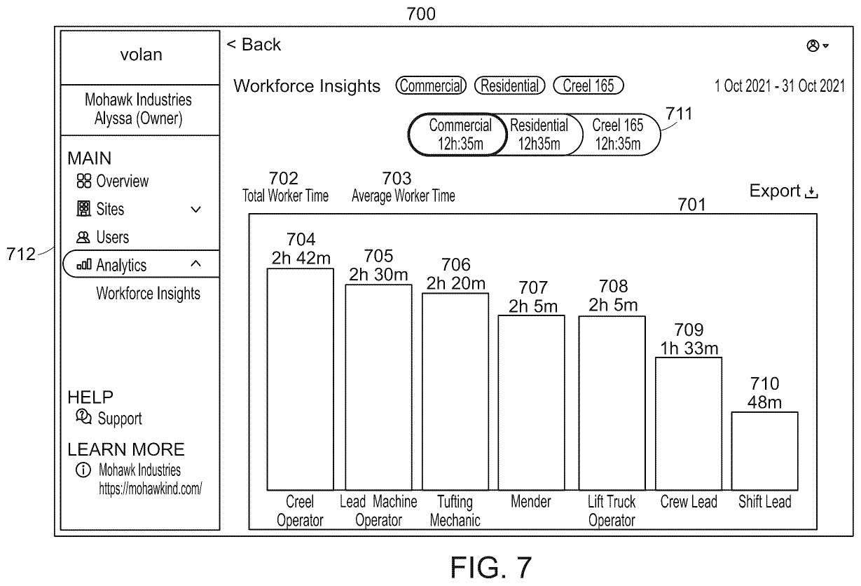

FIG. 7 is an example analytics interface 700 on the dashboard of the positioning system of FIG. 1 according to some embodiments of the present disclosure. The analytics interface 700 can be displayed a mobile device 112 via a platform 114. The various values and analytics can have been generated by the analytics engine 120 on server 118. The analytics interface 700 can include a region 701 that plots total worker time spent in a specific zone (e.g., or average time and other related time values). The region 701 includes a bar graph (although other graphs are possible) that displays how much time various workers spent working, such as a creel operator 704, a lead machine operator 705, a tufting mechanic 706, a mender 707, a lift truck operator 708, a crew lead 709, and a shift lead 710. In addition, the user can view different bar graphs for different zones or view statistics for groups of workers rather than individual workers. As described in relation to the system 100 of FIG. 1, each worker has an associated sensor 106 that is tracked by periodically outputting its location to various beacons 104, which is then transmitted to the server 118 and stored in the point cloud module 124. Because each sensor 106 has a unique ID and is associated with a specific role (e.g., creel operator, mender, crew lead, etc.), the analytics engine 120 can access the point cloud of location data from point cloud module 124 and compute various values, such as the total time each worker spent working in a certain zone. The analytics engine 120 can then process the time values calculated for the various workers and display same time values in a plot in region 701 for an administrator or other user to view. In some embodiments, the analytics interface 700 can allow the user to switch between viewing total worker time 702 or average worker time 703. In addition, the analytics interface 700 can include a toggle selector 711 for viewing commercial work, residential work, and creel 165 work. Finally, the analytics interface 700 can include a menu 712 that enables a user to select different pages to view on the platform, such as an overview of the monitored workforce, sites (i.e., to view live maps for sites/zones such as described in FIGS. 5 and 6), users, and analytics.

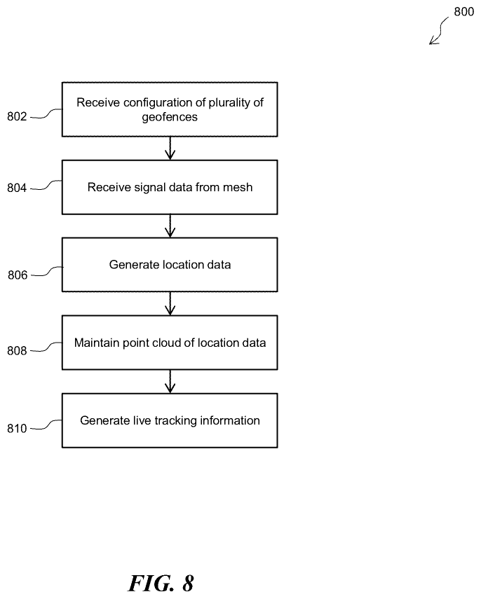

FIG. 8 is an example method 800 for generating live tracking information within the system of FIG. 1 according to some embodiments of the present disclosure. In some embodiments, process 800 is performed by server 118 in connection with a mesh network 101 monitoring a region 102. At block 802, the server 118 receives a configuration of a plurality of geofences. In other words, a plurality of beacons 104 are positioned to define various rooms/zones, and the definition/configuration of the rooms/zones is programmed into the server 118 to define various geofences. Server 118 can use the geofences in future steps to determine the location of a sensor 106 and the associated employee.

At block 804, the server 118 receives signal data from the mesh network 101. In some embodiments, signal data includes various packages generated over time and receiving signal data from the mesh network 101 comprises receiving the packages from one or more gateways 110 over time. As discussed in relation to FIG. 1, a package is generated as follows: a sensor 106 associated with an employee, via the repeater functionality 212, identifies a plurality of nearby beacons 104 (e.g., three beacons). The timing in which the sensor 106 performs such identification can be managed by the report timer functionality 210. The sensor 106 identifies the three nearest beacons 104 and obtains a signal strength value/a received signal strength indicator (e.g., RSSI) from each. The sensor 106 then compiles the beacon IDs, the RSSI's, the sensor ID, a version number, and a timestamp into a package and transmits the package to one or more beacons 104. In some embodiments, the packaged can be transmitted to one or more nearby beacons, such as the nearest beacon, the nearest three beacons, all beacons within a predefined radius, etc. The beacons 104 relay these packages to other beacons 104 until it reaches a proxy 108, in which case it is provided to the gateway 110 and transmitted to the server 118. The server 118 then stores the package as a datapoint in the point cloud module 124. Receiving the signal data from the mesh network 101 therefore can include repeatedly receiving packages from one or more sensors over a period of time.

At block 806, the server 118 generates location data based on the received signal data. In some embodiments, the server 118 determines a location for each package. As packages are received periodically over time (e.g., from each sensor 106 every five seconds), the server 118 can therefore track the location of the sensor 106 over time. In some embodiments, generating a location can include a combination of trilateration and geofencing. For example, the server 118 (e.g., via analytics engine 120) can use a trilateration technique with the RSSIs of a package to determine a position of the sensor 106. Then, the server 118 compares the calculated location to the configuration of geofences, allowing for an accurate determination on which room or zone the sensor 106 is located in. When analyzing a package, if the server 118 determines that the beacons from all three RSSIs are in the same geofence, then the sensor 106 is in that geofence. If only two of the three beacons are in the same geofence and those two beacons are recorded as having the strongest RSSI, then the sensor 106 is determined to be in that geofence. If all three beacons are in different geofences, then the sensor 106 is determined to be in the geofence of the beacon with the strongest RSSI.

At block 808, which can occur in parallel during the general processing of process 800, the server 118 maintains a point cloud (e.g., point cloud module 124) of location data. The point cloud can include, for each sensor 106, a plurality of location points over time, which can be used at block 810. At block 810, the server 118, via analytics engine 120, generates live tracking information for the one or more sensors 106 being tracked. Generating live tracking information can include rendering and displaying a live map of the monitored zone or region and indicators or tracking objects of each sensor on the map, such as the live maps discussed in FIGS. 5 and 6.

FIG. 9 is an example method 900 for generating alerts within the system of FIG. 1 according to some embodiments of the present disclosure. In some embodiments, process 900 is performed by server 118 in connection with a mesh network 101 monitoring a region 102. In some embodiments, blocks 902-908 can be similar to blocks 802-808 of process 800. At block 902, the server 118 receives a configuration of a plurality of geofences. In other words, a plurality of beacons 104 are positioned to define various rooms/zones, and the definition/configuration of the rooms/zones is programmed into the server 118 to define various geofences. Server 118 can use the geofences in future steps to determine the location of a sensor 106 and the associated employee.

In some embodiments, the geofence configuration can include various rules for monitoring the workforce. In one example, the geofence configuration can include specific definitions that designate certain rooms as off-limits and inaccessible by certain personnel. For example, it is common for airport worksites to have certain restricted zones where workers are not allowed to enter. When defining the geofence configurations and positioning the beacons, beacons can be positioned around the restricted zone to define said restricted zone. The geofence can be enabled in the system and then designated as a restricted zone to be monitored. Another example of a rule can include a limit on how many workers a supervisor (or other similar type of employee) can supervise. In some industries, there may legal or other types of constraints that a workforce must adhere to regarding supervisors and the employees they are supervising. For example, a supervisor in a certain type of work area may only be legally allowed to oversee five employees. In such a scenario, the configuration could include a threshold number of employees of a certain role that are able to operate within the vicinity of a single employee of another role. In some embodiments, a “vicinity” can refer to the same geofence, whether that be a room or zone in a workplace. In other embodiments, a “vicinity” can refer to a pre-defined distance value (e.g., fifty feet). In other embodiments, a “vicinity” can include a combination of both (e.g., within fifty feet and within the same geofence).

At block 904, the server 118 receives signal data from the mesh network 101. As described above, signal data includes various packages generated over time by sensors 106 and receiving signal data from the mesh network 101 comprises receiving the packages from one or more gateways 110 over time. Packages can be generated in the same manner as discussed above and are then received by the server 118. Each package can contain data such as the relevant beacon IDs, the RSSI's for the beacons, a relevant sensor ID, a version number, and a timestamp.

At block 906, the server 118 generates location data based on the received signal data. In some embodiments, the server 118 generates a location for each package. As discussed above, packages are received periodically over time and the server 118 can therefore track the location of sensors 106 over time, such as via a combination of trilateration and geofencing. In some embodiments, generating a location can include a combination of trilateration and geofencing. At block 908, which can occur in parallel during the general processing of process 900, the server 118 maintains a point cloud (e.g., point cloud module 124) of location data.

At block 910, the server 118, via the alerting module 122, determines that a sensor has violated a geofence rule. For example, the server 118 can determine that the location of a sensor 106 is within the geofence of a restricted zone. In another example, the server 118 can determine that the location of a sensor 106 is approaching the geofence of a restricted zone. In another example, the server 118 can determine that a supervisory threshold rule has been violated. This can include locating a first number of employees of a first role within a geofence, locating a second number of employees of a second role within the geofence (i.e., a supervisor), and determining that the first number exceeds a supervisory threshold associated with the employee(s) of the second role. At block 912, in response to determining that a geofence rule has been violated, the alerting module 122 generates an alert. The alert can be displayed on the platform 114 on a mobile device 112. In some embodiments, the alert can be transmitted to a mobile device 112 or other device separate from the platform 114, such as via text, chat, or email. In some embodiments, the alert can pinpoint the location of the violation on a live map (see indicator 605 of live map 600).

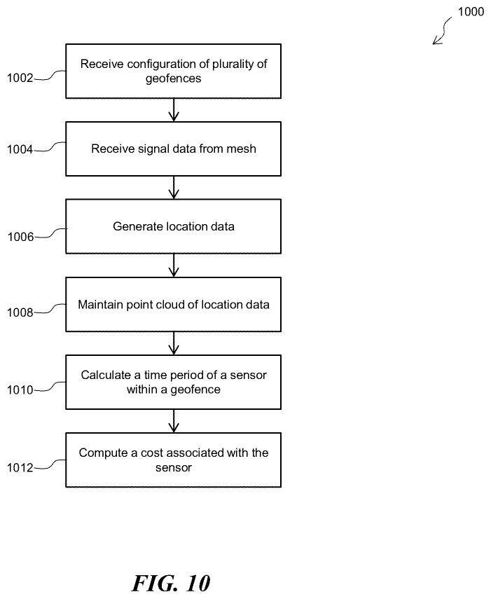

FIG. 10 is an example method 1000 for computing a labor cost within the system of FIG. 1 according to some embodiments of the present disclosure. In some embodiments, process 1000 is performed by server 118 in connection with a mesh network 101 monitoring a region 102. In some embodiments, blocks 1002-1008 can be similar to blocks 802-808 of process 800. At block 1002, the server 118 receives a configuration of a plurality of geofences. In other words, a plurality of beacons 104 are positioned to define various rooms/zones, and the definition/configuration of the rooms/zones is programmed into the server 118 to define various geofences. Server 118 can use the geofences in future steps to determine the location of a sensor 106 and the associated employee. In some embodiments, the configuration can include geofences more granular than rooms or zones, such as geofences within geofences. For example, a plurality of beacons 104 (e.g., four) can be positioned around a particular machine (e.g., at a manufacturing facility) to define a “machine geofence.” In cases where a machine geofence is configured, the configuration can include a cost

At block 1004, the server 118 receives signal data from the mesh network 101. As described above, signal data includes various packages generated over time by sensors 106 and receiving signal data from the mesh network 101 comprises receiving the packages from one or more gateways 110 over time. Packages can be generated in the same manner as discussed above and are then received by the server 118. Each package can contain data such as the relevant beacon IDs, the RSSI's for the beacons, a relevant sensor ID, a version number, and a timestamp.

At block 1006, the server 118 generates location data based on the received signal data. In some embodiments, the server 118 generates a location for each package. As discussed above, packages are received periodically over time and the server 118 can therefore track the location of sensors 106 over time, such as via a combination of trilateration and geofencing. In some embodiments, generating a location can include a combination of trilateration and geofencing. At block 1008, which can occur in parallel during the general processing of process 1000, the server 118 maintains a point cloud (e.g., point cloud module 124) of location data.

At block 1010, the analytics engine 120 calculates a time period of a sensor 106 within a geofence. Such a calculation includes determining the time at which the sensor 106 entered the geofence (e.g., via the timestamp associated with the package/datapoint generated by the sensor 106 indicating entry into the geofence) and determining the time at which the sensor 106 has exited the geofence. Using the time of arrival and the time of exiting, the analytics engine 120 determines the duration in which the sensor 106 was within the geofence. At block 1012, the analytics engine 120 computes a cost associated with the sensor 106. For example, the sensor 106 can have a labor cost associated with it (e.g., $50/hr). The analytics engine 120 can then compute the total labor cost for the sensor based on the duration of time spent in the geofence. In this manner, the analytics engine 120 can compute costs associated with a plurality of sensors 106 (i.e., various members of a workforce). Such values can be displayed in the platform 114 for a user to gain insights into the efficiencies and cost of their workforce (see FIG. 7). In another example, a labor cost can be a part of the geofence configuration and is associated with a specific machine geofence, which may cost $300/hr to operate. The analytics engine 120 then computes the labor cost for the machine geofence using the duration of time the sensor 106 spent at the machine and the associated labor cost. In some embodiments, multiple machine geofences can be configured and monitored in the same manner. The labor costs for each machine geofence can be accessed via the platform 114, similar to how the labor costs for various employees are accessed and viewed.

FIG. 11 is a diagram of an example server device 1100 that can be used within system 100 of FIG. 1. Server device 1100 can implement various features and processes as described herein. Server device 1100 can be implemented on any electronic device that runs software applications derived from complied instructions, including without limitation personal computers, servers, smart phones, media players, electronic tablets, game consoles, email devices, etc. In some implementations, server device 1100 can include one or more processors 1102, volatile memory 1104, non-volatile memory 1106, and one or more peripherals 1108. These components can be interconnected by one or more computer buses 1110.

Processor(s) 1102 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 1110 can be any known internal or external bus technology, including but not limited to ISA, EISA, PCI, PCI Express, USB, Serial ATA, or FireWire. Volatile memory 1104 can include, for example, SDRAM. Processor 1102 can receive instructions and data from a read-only memory or a random access memory or both. Essential elements of a computer can include a processor for executing instructions and one or more memories for storing instructions and data.

Non-volatile memory 1106 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 1106 can store various computer instructions including operating system instructions 1112, communication instructions 1114, application instructions 1116, and application data 1117. Operating system instructions 1112 can include instructions for implementing an operating system (e.g., Mac OS®, Windows®, or Linux). The operating system can be multi-user, multiprocessing, multitasking, multithreading, real-time, and the like. Communication instructions 1114 can include network communications instructions, for example, software for implementing communication protocols, such as TCP/IP, HTTP, Ethernet, telephony, etc. Application instructions 1116 can include instructions for various applications. Application data 1117 can include data corresponding to the applications.

Peripherals 1108 can be included within server device 1100 or operatively coupled to communicate with server device 1100. Peripherals 1108 can include, for example, network subsystem 1118, input controller 1120, and disk controller 1122. Network subsystem 1118 can include, for example, an Ethernet of WiFi adapter. Input controller 1120 can be any known input device technology, including but not limited to a keyboard (including a virtual keyboard), mouse, track ball, and touch-sensitive pad or display. Disk controller 1122 can include one or more mass storage devices for storing data files; such devices include magnetic disks, such as internal hard disks and removable disks; magneto-optical disks; and optical disks.

FIG. 12 is an example computing device that can be used within the system 100 of FIG. 1, according to an embodiment of the present disclosure. In some embodiments, device 1200 can be mobile device 112. The illustrative user device 1200 can include a memory interface 1202, one or more data processors, image processors, central processing units 1204, and/or secure processing units 1205, and peripherals subsystem 1206. Memory interface 1202, one or more central processing units 1204 and/or secure processing units 1205, and/or peripherals subsystem 1206 can be separate components or can be integrated in one or more integrated circuits. The various components in user device 1200 can be coupled by one or more communication buses or signal lines.

Sensors, devices, and subsystems can be coupled to peripherals subsystem 1206 to facilitate multiple functionalities. For example, motion sensor 1210, light sensor 1212, and proximity sensor 1214 can be coupled to peripherals subsystem 1206 to facilitate orientation, lighting, and proximity functions. Other sensors 1216 can also be connected to peripherals subsystem 1206, such as a global navigation satellite system (GNSS) (e.g., GPS receiver), a temperature sensor, a biometric sensor, magnetometer, or other sensing device, to facilitate related functionalities.

Camera subsystem 1220 and optical sensor 1222, e.g., a charged coupled device (CCD) or a complementary metal-oxide semiconductor (CMOS) optical sensor, can be utilized to facilitate camera functions, such as recording photographs and video clips. Camera subsystem 1220 and optical sensor 1222 can be used to collect images of a user to be used during authentication of a user, e.g., by performing facial recognition analysis.

Communication functions can be facilitated through one or more wired and/or wireless communication subsystems 1224, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 1224. The specific design and implementation of communication subsystems 1224 can depend on the communication network(s) over which the user device 1200 is intended to operate. For example, user device 1200 can include communication subsystems 1224 designed to operate over a GSM network, a GPRS network, an EDGE network, a WiFi or WiMax network, and a Bluetooth™ network. For example, wireless communication subsystems 1224 can include hosting protocols such that device 1200 can be configured as a base station for other wireless devices and/or to provide a WiFi service.

Audio subsystem 1226 can be coupled to speaker 1228 and microphone 1230 to facilitate voice-enabled functions, such as speaker recognition, voice replication, digital recording, and telephony functions. Audio subsystem 1226 can be configured to facilitate processing voice commands, voice-printing, and voice authentication, for example.

I/O subsystem 1240 can include a touch-surface controller 1242 and/or other input controller(s) 1244. Touch-surface controller 1242 can be coupled to a touch-surface 1246. Touch-surface 1246 and touch-surface controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of speaker 1228 and/or microphone 1230.

In some implementations, a pressing of the button for a first duration can disengage a lock of touch-surface 1246; and a pressing of the button for a second duration that is longer than the first duration can turn power to user device 1200 on or off. Pressing the button for a third duration can activate a voice control, or voice command, module that enables the user to speak commands into microphone 1230 to cause the device to execute the spoken command. The user can customize a functionality of one or more of the buttons. Touch-surface 1246 can, for example, also be used to implement virtual or soft buttons and/or a keyboard.

In some implementations, user device 1200 can present recorded audio and/or video files, such as MP3, AAC, and MPEG files. In some implementations, user device 1200 can include the functionality of an MP3 player, such as an iPod™. User device 1200 can, therefore, include a 36-pin connector and/or 8-pin connector that is compatible with the iPod. Other input/output and control devices can also be used.

Memory interface 1202 can be coupled to memory 1250. Memory 1250 can include high-speed random access memory and/or non-volatile memory, such as one or more magnetic disk storage devices, one or more optical storage devices, and/or flash memory (e.g., NAND, NOR). Memory 1250 can store an operating system 1252, such as Darwin, RTXC, LINUX, UNIX, OS X, Windows, or an embedded operating system such as VxWorks.

Operating system 1252 can include instructions for handling basic system services and for performing hardware dependent tasks. In some implementations, operating system 1252 can be a kernel (e.g., UNIX kernel). In some implementations, operating system 1252 can include instructions for performing voice authentication.

Memory 1250 can also store communication instructions 1254 to facilitate communicating with one or more additional devices, one or more computers and/or one or more servers. Memory 1250 can include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic messaging-related process and functions; web browsing instructions 1264 to facilitate web browsing-related processes and functions; media processing instructions 1266 to facilitate media processing-related functions and processes; GNSS/Navigation instructions 1268 to facilitate GNSS and navigation-related processes and instructions; and/or camera instructions 1270 to facilitate camera-related processes and functions.

Memory 1250 can store application (or “app”) instructions and data 1272, such as instructions for the apps described above in the context of FIGS. 8-10 and for modules 120-124. Memory 1250 can also store other software instructions 1274 for various other software applications in place on device 1200.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A positioning system for monitoring a workforce within a site using a wireless mesh network comprising:
a plurality of beacon sets, each beacon set being positioned to define a geofence and comprising a plurality of beacons;
a plurality of portable units, each portable unit being worn or carried by a workforce member and being configured to:
generate a location package at a predefined frequency; and
transmit the location package to a beacon, wherein the beacon relays the location package to other beacons until the location package is collected by a proxy;
a gateway communicably coupled to the proxy and configured to transmit the location package to a server; and
the server, wherein the server is configured to receive the location package and determine a location of the respective portable unit;
wherein the plurality of beacon sets and the plurality of portable units form the wireless mesh network.

2. The positioning system of claim 1, wherein generating the location package comprises:
identifying a plurality of nearby beacons; and
obtaining a received signal strength indicator (RSSI) and a beacon ID for each of the plurality of nearby beacons.

3. The positioning system of claim 2, wherein the location package comprises the RSSI's and beacon IDs for each of the plurality of nearby beacons, a portable unit ID for the respective portable unit, and a timestamp.

4. The positioning system of claim 1, wherein the server is configured to store the location package in a point cloud.

5. The positioning system of claim 1, wherein the predefined frequency is configurable from about one second to about ten minutes.

6. The positioning system of claim 3, wherein determining the location of the respective portable unit comprises using a combination of geofencing and trilateration.

7. The positioning system of claim 6, wherein using a combination of geofencing and trilateration comprises:
processing the RSSI's with a trilateration technique to determine a position;
comparing the determined position to a configuration of the site, the configuration comprising the geofences defined by the plurality of beacon sets;
determining that the position is within a geofence; and
determining that the respective portable unit is located inside the geofence.

8. The positioning system of claim 7, wherein the server is configured to, in response to determining that the respective portable unit is located inside the geofence, cause live tracking information for the respective portable unit to be displayed on a client device.

9. A positioning system for monitoring a workforce within a site using a wireless mesh network comprising:
a server; and
non-transitory computer-readable instructions which, executed by at least one processor, cause the server to perform a process operable to:
receive a configuration of a plurality of geofences within the site, each geofence defines a zone associated with a beacon set;
receive a plurality of location packages from a wireless mesh network, the wireless mesh network comprising the beacon sets, a gateway, and a portable unit being worn or carried by a workforce member, wherein the plurality of location packages are associated with the portable unit;
generate location data for the portable unit based on the plurality of location packages;
maintain a point cloud of the location data; and
providing the location data for display on a client device.

10. The positioning system of claim 9, wherein the location package comprises a plurality of received signal strength indicators (RSSIs), a plurality of beacon IDs, a portable unit ID associated with the portable unit, and a timestamp.

11. The positioning system of claim 9, wherein the server is configured to receive a location package at a predefined frequency.

12. The positioning system of claim 11, wherein the predefined frequency is configurable from about one second to about ten minutes.

13. The positioning system of claim 10, wherein generating the location data for the portable unit comprises processing the plurality of location packages with a combination of geofencing and trilateration.

14. The positioning system of claim 13, wherein processing the plurality of location packages with the combination of geofencing and trilateration comprises:
processing the RSSI's with a trilateration technique to determine a position;
comparing the determined position to the received configuration of the site;
determining that the position is within a geofence; and
determining that the respective portable unit is located inside the geofence.

15. The positioning system of claim 14, wherein providing the location data for display on a device comprises displaying live location data for the portable unit.

16. The positioning system of claim 15, wherein displaying live location data for the portable unit comprises:
displaying a map of the site;
demarcating the plurality of geofences of the site on the map; and
displaying an indicator on the map indicating a current location of the portable unit.

17. The positioning system of claim 16, wherein displaying the live location data for the portable unit further comprises updating the current location of the portable unit at a predefined frequency.

18. The positioning system of claim 9, wherein the server is further configured to:
receive a geofence rule with the configuration;
determine a violation of the geofence rule based on analyzing the location data of the portable unit; and
generating an alert for display on the client device.

19. The positioning system of claim 18, wherein the violation comprises at least one of:
entering a restricted geofence; or
approaching the restricted geofence.

20. The positioning system of claim 9, wherein the server is further configured to compute a labor cost associated with the portable unit.
